(19) United States
(12) Patent Application Publication
(10) Pub. No.: US 2014/0161446 A1
(43) Pub. Date: Jun. 12, 2014

(54) OPTICAL AMPLIFIER (OA)-BASED REACH EXTENDER AND PASSIVE OPTICAL NETWORK SYSTEM INCLUDING THE SAME

(71) Applicant: Electronics and Telecommunications Research Institute, Daejeon-si (KR)

(72) Inventors: Han-Hyub LEE, Daejeon-si (KR); Sang-Soo LEE, Daejeon-si (KR)

(73) Assignee: Electronics and Telecommunications Research Institute, Daejeon-si (KR)

(21) Appl. No.: 14/092,297

(22) Filed: Nov. 27, 2013

(30) Foreign Application Priority Data
Nov. 28, 2012 (KR) 10-2012-0136474
Nov. 27, 2013 (KR) 10-2013-0145453

(51) Int. Cl. H04J 14/02; H04B 10/079; H04J 14/08

(52) U.S. Cl. CPC H04J 14/0221; H04J 14/08; H04B 10/07955
USPC 398/34; 398/67

(57) ABSTRACT

The TWDM-PON system includes a service provider equipment configured to comprise a plurality of Optical Line Terminals (OLTs), wherein each OLT provides a service in a TWDM scheme; a subscriber equipment configured to comprise a plurality of an Optical Network Units (ONUs), wherein each of the plurality of ONUs utilizes a service provided from one of the plurality of OLTs using an optical signal of an arbitrary wavelength; an Optical Division Network (ODN) configured to transmit multi-wavelength downstream optical signals and multi-wavelength upstream optical signals; and a Reach Extender (RE) configured to comprise at least one of a downstream optical amplifier and an upstream optical amplifier, wherein the downstream optical amplifier is configured to amplify the multi-wavelength optical signals simultaneously, and the upstream optical amplifier is configured to amplify the multi-wavelength optical signals simultaneously.

### CROSS-REFERENCE TO RELATED APPLICATION(S)

This application claims the benefit under 35 U.S.C. §119(a) of Korean Patent Application Nos. 10-2012-0136474, filed on Nov. 28, 2012, and 10-2013-0145453, filed on Nov. 27, 2013, in the Korean Intellectual Property Office, the entire disclosures of which are incorporated herein by references for all purposes.

### BACKGROUND

1. Field

The following description relates to a Passive Optical Network (PON), and more particularly, an Optical Amplifier (OA)-based reach extender and a PON system including the same.

2. Description of the Related Art

A Time Division Multiplexing Passive Optical Network (TDM-PON), such as Ethernet Passive Optical Network (EPON) and Gigabit capable PON (GPON), connects a base station and subscribers using a single upper wavelength optical signal and a single lower wavelength optical signal. In addition, the TDM-PON employs an optical splitter that does not require power consumption to connect a base station and subscribers. Due to these advantages, TDM-PON has been widely spread and used worldwide. In particular, the GPON is now common across the North America and European countries. In 2010, an International Telecommunications Union Telecommunication (ITU-T) has developed G.987 XG-PON recommended standard and now an early-stage commercial product has been released. In addition, Full Service Access Network (FSAN), a ITU-T SG15 Q2 forum for the world's leading telecommunications services providers and equipment suppliers to work toward pre-standardization, has adapted Time and Wavelength Division Multiplexing Passive Optical Network (TWDM-PON) as a main technology. The ITU-T is now discussing adaption of TWDM-PON as G.989.x recommended standard.

FIG. 1 is a block diagram illustrating a configuration of a TWDM-PON. As shown in FIG. 1, the TWDM-POM system is used to provide subscribers with a broadband service by combining a TDB-based signal transmission technology (e.g., an XG-PON technology) and a Wavelength Division Multiplex (WDM)-based signal transmission technology of multiplexing multiple optical signals of different wavelengths to be transmitted. In this case, an Optical Line Terminal (OLT) may be physically realized as a plurality of entities and systematically include a is multiple wavelength transceivers to transmit and receive optical signals of multiple wavelengths. In addition, an Optical Distribution Unit (ODN) divides received downstream signals of multiple wavelengths (λ1, λ2, λ3, λ4) to be transmitted to each of Optical Network Units (ONUs) (to this end, each ODN may include a splitter) or transmits multiple wavelength signals (λ5, λ6, λ7, λ8) combined with upstream signals of a specific wavelength, which are received from multiple ONUs. Since having a tunable transceiver, each ONU may enjoy a service using an arbitrary wavelength. Yet, in the view of network management, a wavelength used by each ONU may be controlled by an Optical Line Termination (OLT).

Meanwhile, since link budget is limited, deployment of an optical network in the PON system is necessarily limited. The link budget refers to an amount of losses, which is allowable in an optical link to the extent that a signal may be transmitted without an error. For example, primary optical link losses incurred in a TDM-PON system are largely losses incurred in an optical fiber constituting an optical transmission line and losses incurred due to branch of an optical splitter. Those losses in an optical link may happen even in the TWDM-PON system. The smaller a link budget, the closer the distance between an OLT and an ONU becomes. Thus, there have been many proposals of increasing a link budget for an efficient optical network deployment in the PON system.

As a solution to increasing a link budget or a transmission distance of an optical signal, it is considered to decreasing branches of a splitter and to add a Reach Extender (RE). Using the former solution, it is possible to reduce losses in an optical link by decreasing branches of the splitter. Yet, it may result in a reduced number of service available ONUs due to the reduced branches of the splitter. Due to this drawback, the latter solution of adding an RE is regarded more effective.

FIG. 2 is a conceptual diagram illustrating a procedure of increasing a transmission distance, that is, a link budget by adding a Reach Extender (RE) in an existing Passive Optical Network (PON) system. Referring to FIG. 2, the existing PON system includes an Optical Line Terminal (110) and a plurality of Optical Network Units (ONUs) 140, and further includes a Reach Extender (RE) 120. By adding the RE 120 to the existing PON system, a link budget of the PON system may increase to be Budget1+Budget2.

There are two types of the RE: an Optical Amplifier (OA) and an Optical-Electro-Optical (OEO) regenerator. The OA provides advantages in terms of optical power. In addition, the OEO regenerator generates an optical signal, reshapes and retime the signal in an electrical domain, amplify transmit the reshaped and retimed optical signal, and transmit the amplified optical signal in the optical domain again.

FIG. 3 is a block diagram illustrating an example of an existing Optical-Electrical-Optical (OEO)-based Reach Extender (RE). Referring to FIG. 3, an existing OEO-based RE 122 receives an optical signal at a receiving end (Rx), transforms and amplifies the received optical signal through logic, and then transmitted the transformed optical signal through a transmitter (Tx). The OEO-based RE 122 has an advantage in a TDM-PON system in which each of an upstream signal (Up: λ1′) and a downstream signal (Dn: λ1) has only one channel.

Yet, the RE 122 shown in FIG. 3 is not adequate for a TWDM-PON system in which a plurality of upstream signals (e.g., four or more upstream signals) and a plurality of downstream is signals (e.g., four or more downstream signals) are provided. FIG. 4 is a diagram illustrating a case where the RE shown in FIG. 3 is applied in a TWDM-PON system. As illustrated in FIG. 4, an RE 124 applied in the TWDM-PON system needs a DeMUX and a MUX for each of the upstream signals (Up: λ1′˜λ8′) and downstream signals (Dn: λ1˜λ8), and has to make use of a plurality of receiving ends (Rx), a logic and a transmitters (Tx), so that the RE 124 may have a considerably complex structure.

### SUMMARY

In one general aspect, there is provided a Time Wavelength Division Multiplexing-Passive Optical Network (TWDM-PON) system including: a service provider equipment configured to comprise a plurality of Optical Line Terminals (OLTs), wherein each of the plurality of OLT provides a service using an optical signal of different wavelength in Time Division Multiplexing (TDM) scheme; a subscriber equipment configured to comprise a plurality of an Optical Network Units (ONUs), wherein each of the plurality of ONUs utilizes a service provided from one of the plurality of OLTs using an optical signal of an predetermined wavelength, the predetermined wavelength being selected according to wavelength control of the service provider equipment; an Optical Division Network (ODN) configured to transmit multi-wavelength downstream optical signals from the service provider equipment to the subscriber equipment and to transmit multi-wavelength upstream optical signals transmitted from the subscriber equipment to the service provider equipment; and a Reach Extender (RE) configured to comprise at least one of a downstream optical amplifier and an upstream optical amplifier, wherein the downstream optical amplifier is configured to amplify the multi-wavelength optical signals simultaneously, and the upstream optical amplifier is configured to amplify the multi-wavelength optical signals simultaneously.

The upstream optical amplifier may be a semiconductor optical amplifier.

The semiconductor optical amplifier may be either a gain-clamped semiconductor optical amplifier or a Raman optical fiber amplifier.

The RE may be configured to comprise a splitter configured to split the multi-wavelength downstream optical signals received from the service provider equipment; an embedded Optical Network Equipment (ONT) configured to generate a monitoring signal that comprises information required to control an operational state of the downstream optical amplifier; and a tunable transceiver configured to receive an optical signal of a specific wavelength from among the multi-wavelength downstream signals split by the downstream splitter, and to transmit the generated monitoring signal of a wavelength corresponding to the specific wavelength.

The monitoring signal may include at least one of information on an R/S physical interface supported by an OLT that has established communication link to the embedded ONT, information on the downstream optical amplifier, and general indicators of the downstream optical amplifiers.

The information on an R/S physical interface may include at least one of managed entity identification (ID), an administrative state, an operational state, an optical signal level, a lower optical threshold, an upper optical threshold, a transmit optical level, a lower transmit power threshold, an upper transmit power threshold, and a usage mode.

The information on the downstream optical amplifier may include at least one of managed entity ID, an administrative state, an operation state, ARC, an ARC interval, an input optical signal level, a lower input optical signal threshold, an upper input optical signal threshold, an output optical signal level, a lower output optical signal threshold, an upper output optical threshold, and an RS splitter coupling rate.

The general indicators of the downstream optical amplifiers may include at least one of managed entity ID, a gain, a lower gain threshold, an upper gain threshold, a target gain, device temperatures, a lower device temperature threshold, an upper device temperature threshold, a device bias current, an amplifier saturation output power, an amplifier saturation gain, and an amplifier noise figure.

The RE may be further configured to comprise an upstream splitter configured to split the multi-wavelength upstream optical signals received from the subscriber equipment, and a tunable receiver configured to receive an optical signal of a specific wavelength from among the multiple-wavelength upstream optical signals split by the upstream splitter, wherein the monitoring signal generated by the embedded ONT further comprises information required to control an operational state of the upstream optical amplifier.

The information required to control an operational state of the upstream optical amplifier may include at least one of managed ID, an administrative state, an operational mode, an operational state, an RE upstream amplifier pointer, a total optical receive signal level table, a per burst receive signal level table, a lower receive optical threshold, an upper receive optical threshold, a transmit optical level, a lower transmit optical threshold, and an upper transmit optical threshold.

The embedded ONT may establish communication link to the plurality of OTL sequentially to transmit the monitoring signal to each OLT that has established communication link thereto.

The embedded ONT may establish communication link to one OLT among a plurality of OLTs in response to a control signal from the specific OLT, so that the embedded ONT transmits the monitoring signal to the OLT.

The RE may be configured to compromise a splitter configured to split the multi-wavelength downstream optical signals received from the service provider equipment; an embedded ONT configured to generate a monitoring signal that comprises information required to control an operational state of the downstream optical amplifier, and a multi-wavelength optical receiver configured to comprise a downstream optical DeMux, a downstream multi-wavelength receiver, a multi-wavelength light source and a mux, wherein the downstream optical DeMux is configured to demultiplex the multi-wavelength downstream optical signals split by the downstream splitter, a downstream multi-wavelength receiver is configured to receive downstream optical signals that are demultiplexed by the downstream optical DeMux, a multi-wavelength light source is configured to transmit signals of various wavelengths, and a mux is configured to multiplex the signals of various wavelengths output from the multi-wavelength light source.

The monitoring signal may include at least one of an R/S physical interface supported by an OLT that has established communication link to the embedded ONT, information on the downstream optical amplifier, and general indicators of the downstream optical amplifier.

The RE may be further configured to comprise an upstream splitter configured to split the multi-wavelength upstream optical signals received from the subscriber equipment; an upstream DeMux configured to demultiplex the multi-wavelength upstream optical signals split by the upstream splitter; and a tunable receiver configured to receive the upstream optical signals demultiplexed by the upstream DeMux, wherein the monitoring signal generated by the embedded ONT further comprises information required to control an operational state of the upstream optical amplifier.

In another general aspect, there is provided a Reach Extender (RE) for increasing a link budget of a Time Wavelength Division Multiplexing-Passive Optical Network (TWDM-PON) system, the RE comprising: a downstream splitter configured to split multi-wavelength downstream optical signals received from a service provider equipment in the TWDM-PON system; an embedded Optical Network Terminal (ONT) configured to generate a monitoring signal that comprises information required to control an operational state of the downstream optical amplifier; and a tunable transceiver configured to receive an optical signal of a specific wavelength from among the multi-wavelength downstream optical signals split by the downstream splitter, and to transmit the generated monitoring signal of a wavelength corresponding to the specific wavelength.

The monitoring signal may include at least one of an R/S physical interface supported by an OLT that has established communication link to the embedded ONT, information on the downstream optical amplifier, and general indicators of the downstream optical amplifier.

The RE may further include an upstream splitter configured to split the multi-wavelength upstream optical signals received from the subscriber equipment; and a tunable receiver configured to receive an optical signal of a specific wavelength from among the multi-wavelength upstream optical signals split by the upstream splitter, wherein the generated monitoring signal further comprises information required to control an operational state of the upstream optical amplifier.

The embedded ONT may establish communication link to a plurality of Optical Line Terminals (OLTs) sequentially to transmit the monitoring signal to each OLT that has established communication link thereto.

The embedded ONT may establish communication link to one OLT among a plurality of OLTs in response to a control signal from the OLT so that the embedded ONT transmits the monitoring signal to the OLT.

Other features and aspects may be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is diagram illustrating an example of a Time Wavelength Division Multiplexing Passive Optical Network (TWDM-PON).

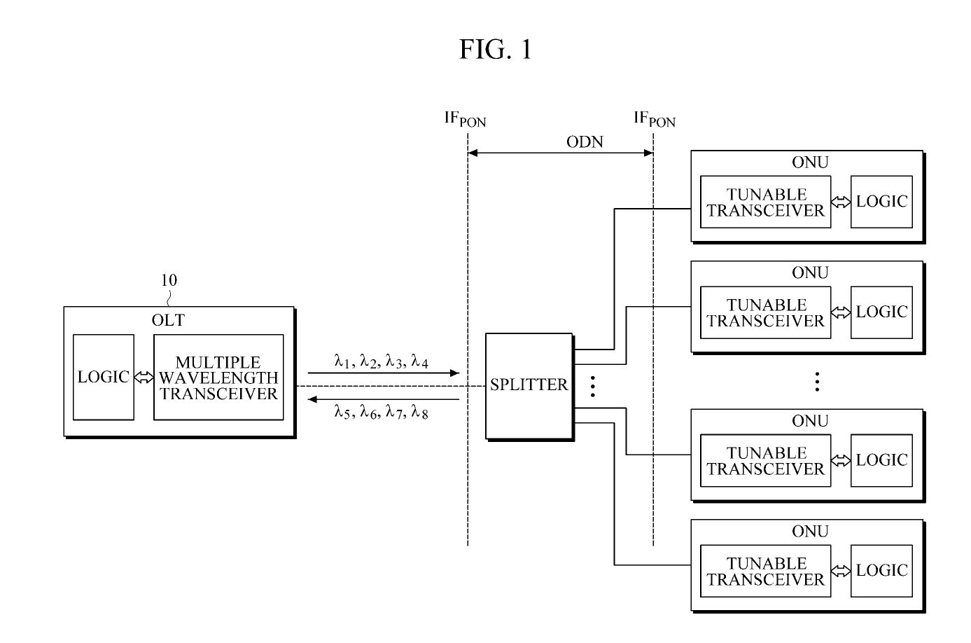

FIG. 2 is a diagram illustrating a procedure of increasing a link budget by inserting a Reach Extender (RE) into a Passive Optical Network (PON) system.

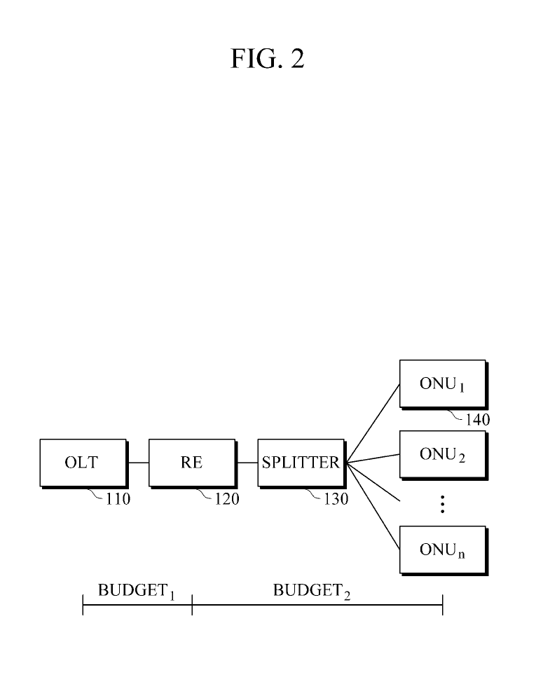

FIG. 3 is a block diagram illustrating an example of an existing Optical-Electrical-Optical (OEO)-based Reach Extender (RE).

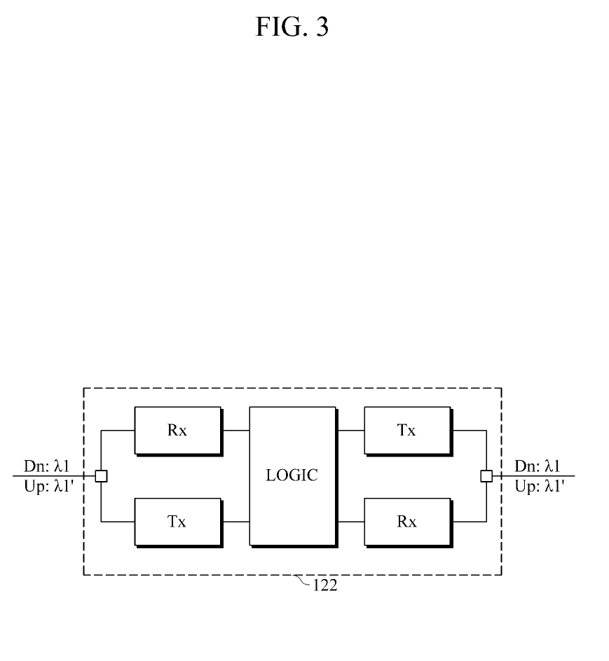

FIG. 4 is a block diagram illustrating a configuration of an Optical Amplifier (OA)-based RE in the case where the RE shown in FIG. 3 is applied in a TWDM-PON system.

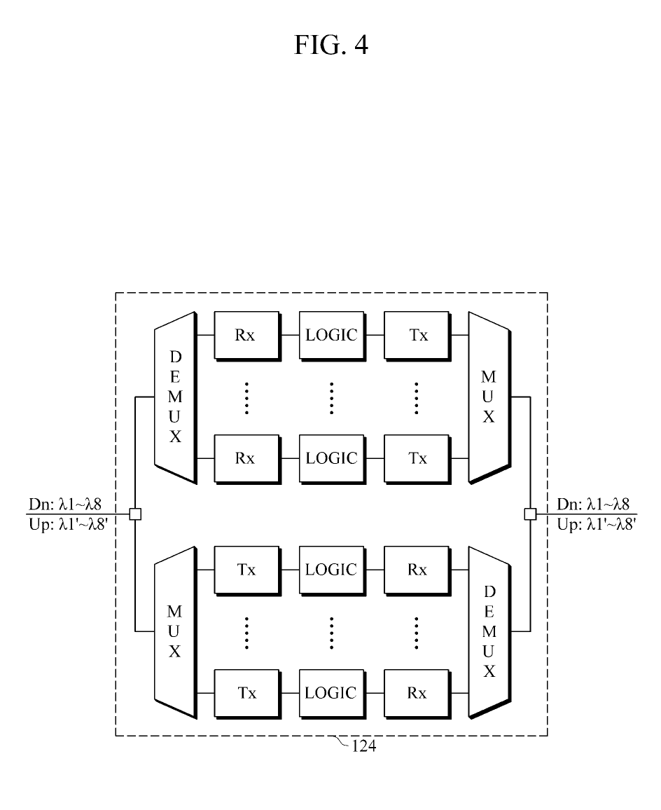

FIG. 5 is a configuration diagram illustrating an Optical Amplifier (OA)-based Reach Extender (RE) that is able to be inserted into a TWDM-PON system according to an exemplary embodiment.

FIG. 6 is a configuration diagram illustrating a TWDM-PON system including an RE according to an exemplary embodiment.

FIG. 7 is a configuration diagram illustrating a TWDM-PON system including an RE according to still another exemplary embodiment.

FIG. 8 is a configuration diagram illustrating a TWDM-PON system including to an RE according to yet another exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, equipments, and/or systems described herein. Accordingly, various changes, modifications, and equivalents of the methods, equipmentes, and/or systems described herein will be suggested to those of ordinary skill in the art. Also, descriptions of well-known functions and constructions may be omitted for increased clarity and conciseness.

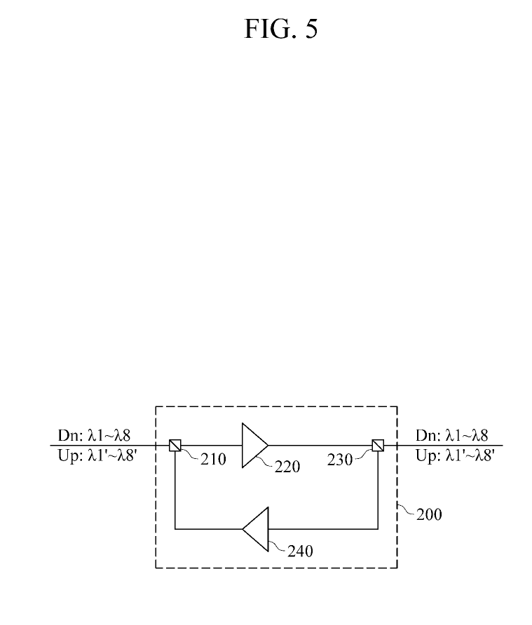

FIG. 5 is a configuration diagram illustrating an Optical Amplifier (OA)-based Reach Extender (RE) which may be inserted into a Time Wavelength Division Multiplexing-Passive Optical Network (TWDM-PON) system according to an exemplary embodiment of the present invention. Referring to FIG. 5, an OA-based RE 200 includes a Wavelength Division Multiplexing (WDM) filter 210, a downstream optical amplifier 220, a second WDM filter 230 and an upstream optical amplifier 240.

Each of the first and second WDM filters 210 and 230 is a diplexer which splits a wavelength of the downstream signal (Dn) and a wavelength of the upstream signal (Up) based on bandwidth. More specifically, the first WDN filter 210 splits a wavelength of a downstream signal (Dn) coming from the left to the right and a wavelength of an upstream signal (Up) coming from the bottom to the left below the downstream signal (Dn). In addition, the second WDM filter 230 splits a wavelength of the downstream signal (Dn) coming from the left to the right and a wavelength of the upstream signal (Up) coming from the right to the bottom. Each of the first and second WDM filters 210 and 230 may be replaced by an optical circulator.

In this embodiment, each of the downstream optical amplifier 220 and the upstream optical amplifier 240 may amplify WDM signals of multiple channels. That is, each of the downstream optical amplifier 220 and the upstream optical amplifier 240 may simultaneously amplify downstream optical signals (Dn: λ1˜λ8) of multiple wavelengths and upstream optical signals (Up: λ1′˜λ8′) of multiple wavelengths, respectively. Since being capable of amplifying optical signals of multiple wavelengths simultaneously, as described above, each of the downstream optical amplifier 220 and the upstream optical amplifier 240 has properties that are suitable for an RE in a TWDM-PON system.

The RE 200 in FIG. 5 includes both the downstream optical amplifier 220 and the upstream optical amplifier 240, but it is merely exemplary. That is, the RE 200 may include either the downstream optical amplifier 220 or the upstream optical amplifier 240, and may further include another optical amplifier of a different type (e.g., an Optical-Electrical-Optical (OEO) amplifier).

According to one aspect of this embodiment, the upstream optical amplifier 240 may be a semiconductor optical amplifier because an upstream signal is bursty in a TWDM-PON system. Specifically, burst-mode signals of multiple channels are simultaneously input to the upstream optical amplifier 240 in the TWDM-PON system, since the upstream optical amplifier 240 is configured as a semiconductor optical amplifier that is able to amplify burst-mode signals of multiple wavelengths without distortion. For example, the upstream optical amplifier 240 may be a gain-clamped semiconductor optical amplifier or a Raman optical fiber amplifier, but the present disclosure is not limited thereto.

Meanwhile, the downstream optical amplifier 220 may include an Erbium-doped Fiber Amplifier (EDFA), but it is merely exemplary. For example, for miniaturization and integration of the RE 200 that includes the downstream optical amplifier 220 and the upstream optical amplifier 240, the downstream optical amplifier 220 and any other optical amplifiers may be configured as semiconductor optical amplifiers.

Although not illustrated in FIG. 5, each output end of the downstream optical amplifier 220 and the upstream optical amplifier 240 may further include an Optical Bandpass Filter (OBF). The OBF is configured to limit a bandwidth of Amplified Spontaneous Emission (ASE) which is amplified by each of the downstream optical amplifier 220 and the upstream optical amplifier 240 to reduce ASE-ASE bit noise and ASE-based power-offset in order to achieve performance improvements. Yet, when the OBF is used, a transmitter may need to have a limited wavelength range.

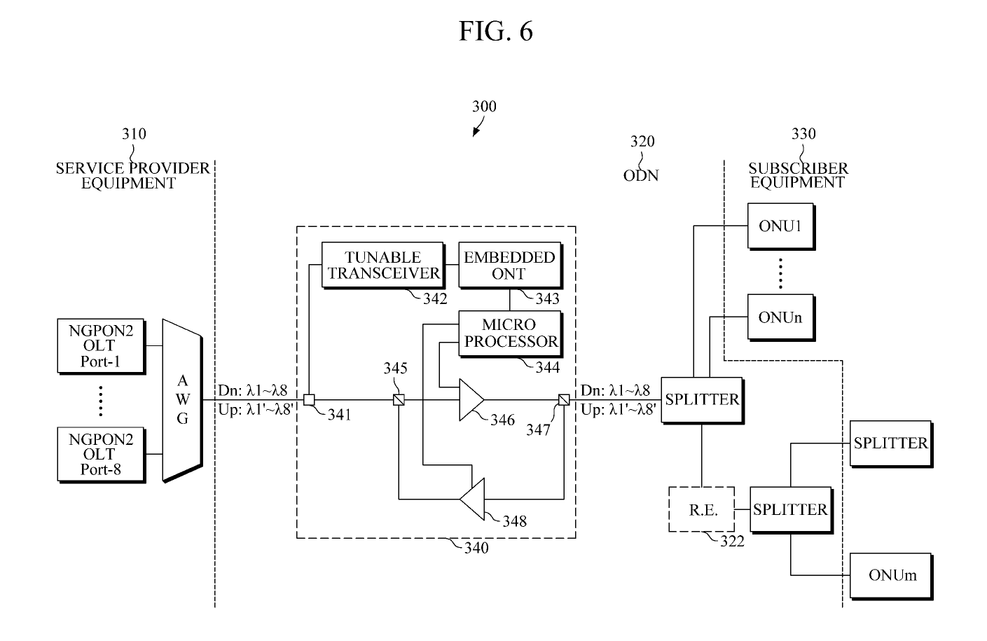

FIG. 6 is a configuration diagram illustrating a Time Wavelength Division Multiplexing-Passive Optical Network (PON) including an RE according to an exemplary embodiment of the present invention. Referring to FIG. 6, a TWDM-PON system 300 includes a service provider equipment 310, an ODN 320 and a subscriber equipment 330. The configurations of the service provider equipment 310, the ODN 320 and the subscriber equipment 330 in FIG. 6 are merely exemplary. In addition, in this embodiment, the TWDM-PON system further includes an RE 340 that is embedded in the ODN 320. The RE 340 may be arranged between the service provider equipment 310 and the ODN 320, but is not limited thereto. That is, the RE 340 may be installed in a front end and/or a back-end of a splitter in the ODN 330.

The service provider equipment 310 may include only one Optical Line Terminal (OLT) or a plurality of OLTs. In this embodiment, each OLT constituting the service provider equipment 310 may be a device that provides a service using multiple wavelengths. Alternatively, each OLT constituting the service provider equipment 310 may be a device that provides a service using a single wavelength, and, in this case, the service provider equipment 310 includes a plurality of OLTs. FIG. 6 illustrates a case where the service provider equipment 310 includes eight Next Generation-Passive Optical Network 2 (NGPON2) OLTs (Port-1 to Port-8), but it is merely exemplary. In FIG. 6, the service provider equipment 310 including a plurality of NGPON2 OLTs (e.g., eight NGPON2 OLTs) may be a hybrid system that combines TDM and WDM. This configuration is appropriate to accommodate a plurality of homogeneous or heterogeneous service links using multiple-wavelength optical signals. In this case, when it is assumed that each NGPON2 OLT accommodates a single TDM PON link, an ODN accommodates n number of homogeneous or heterogeneous networks, and each service may be distinguishable according to a wavelength bandwidth of a signal that is used for a corresponding service.

The subscriber equipment 330 includes a plurality of Optical Network Units (ONUs). FIG. 6 illustrates a case where the subscriber equipment 330 includes m number of ONUs (1 . . . n, n+1, . . . , m), but it is merely exemplary. For example, the entire subscriber equipment 330 or a part of the subscriber equipment 330 may consist of NGPON2 ONUs to receive wave-multiplexed downstream optical signals from a plurality of NGPON2 OLTs. To this end, the subscriber equipment 330 may include a tunable transceiver which is capable of selecting a wavelength.

The RE 340 is designed to increase a link budget of the TWDM-PON system 300 that accommodates multiple wavelengths. The basic configuration and operational principle of the RE 340 may be the same as those of the RE 200 shown in FIG. 5. Thus, the RE 340 may include a first WDM filter 347 configured to amplify upstream optical signals (Up: λ1′˜λ8′), an upstream optical amplifier 348, a second WDM filter 345 configured to amplify downstream optical signals (Dn: λ1˜λ8), and a downstream optical amplifier 346. However, the TWDM-PON system 300 does not necessarily include only one RE. It means that, if necessary, the TWDM-PON system 300 may further include a single RE 322 or a plurality of REs 322 on the ODN 320.

In general, the RE 340 is installed in a remote place, so it is required for a network operator to monitor an operational state of the RE 340 for maintenance and management. In the case of an RE used in the conventional G-PON or XG-PON, the RE is connected to a single OLT, so that a network operator is able to monitor an operational state of an RE through communication between the OLT and the RE. However, in this exemplary embodiment, the RE 340 is connected to the service provider equipment 310 consisting of a plurality of OLTs, so that a plurality of OLTs and the RE 340 have to communicate with each other using a plurality of communication link channels.

To this end, the RE 340 may further include a downstream splitter 341, a tunable transceiver 342, and an embedded Optical Network Equipment (ONT) 343. The downstream splitter 341 is configured to split a downstream optical signal. The tunable transceiver 342 is configured to receive an optical signal of a specific wavelength among downstream optical signals split by the downstream splitter 341 and to transmit an upstream optical signal corresponding to the specific wavelength. The RE 340 may further include a microprocessor 344 configured to manage an operational state of an optical module.

The tunable transceiver 342 may communicate with a specific OLT using a specific wavelength from among a plurality of OLTs that constitute the service provider equipment 310, and/or may communicate with each of the plurality of OLTs. To this end, the embedded ONT 343 may establish communication link to an OLT corresponding a specific wavelength, which the tunable transceiver 342 receives, from among the plurality of OLTs. That is, the embedded ONT 343 may collect information to be transmitted to an OLT, which has established communication link to the embedded ONT 343 through the tunable transceiver 342, for maintenance and management, and then the wavelength transceiver 342 may be controlled to transmit the collected information to the OLT. For example, when the tunable transceiver 342 selects a wavelength λ1 to thereby be connected to a NGPON2 OLT Port-1, the embedded ONT 343 may transmit operational information of the RE 340 to the NGPON2 OLT Port-1.

The tunable transceiver 342 may periodically change a reception wavelength thereof so that all the OLTs (NGPON2 OLT Port-1˜NGPON2 OLT Port-8) constituting the service provider equipment 310 may establish communication link to the embedded ONT 343. In this case, the tunable transceiver 342 may change reception wavelengths sequentially according to a preset order. Accordingly, all OLTs which has established communication link to the embedded ONT 343 may be designed to receive operational information of the RE 340. Alternatively, the tunable transceiver 342 may sequentially establish communication link to all or some of the OLTs included in the service provider equipment 310, may sequentially establish communication link to all or some of the OLTs according to an order that is set by a specific OLT (e.g., an MGPON2 OLP Port-1), or may sequentially establish communication link to all or some of the OLTS only when a request is received from a specific OLT.

In this embodiment, the embedded ONT 343 may generate a monitoring signal including information on an R/S physical interface supported by an OLT that has established communication link to the embedded ONT 343. The embedded ONT 343 may transmit the generated monitoring signal to the OLT through the tunable transceiver 342. Herein, the R/S physical interface indicates an ONU physical interface for an ODN. In addition, the information on the R/S physical interface supported by an OLT that has established communication link to the embedded ONT 343 may include at least one of managed entity identification (ID), an administrative state, an operational state, an optical signal level, a lower optical threshold, an upper optical threshold, a transmit optical signal level, a lower transmit power threshold, an upper transmit power threshold, and a usage mode.

In addition, the embedded ONT 343 may generate a monitoring signal including information on the downstream optical amplifier 346, and transmit the generated monitoring signal to an OLT that has established communication link thereto through the tunable transceiver 342. The information on the downstream optical amplifier 346 may include at least one of managed entity ID, an administrative state, an operation state, ARC, an ARC interval, an input optical signal level, a lower input optical signal threshold, an upper input optical signal threshold, an output optical signal level, a lower output optical signal threshold, an upper output optical threshold, and an RS splitter coupling rate.

In addition, the embedded ONT 343 may generate a monitoring signal including general indicators of the optical amplifiers 346 and 348, and transmit the generated monitoring signal to the OLT that has established communication link thereto through tunable transceiver 342. Herein, the general indicators of the optical amplifiers 346 and 348 may include at least one of managed entity ID, a gain, a lower gain threshold, an upper gain threshold, a target gain, device temperatures, a lower device temperature threshold, an upper device temperature threshold, a device bias current, an amplifier saturation output power, an amplifier saturation gain, and an amplifier noise figure.

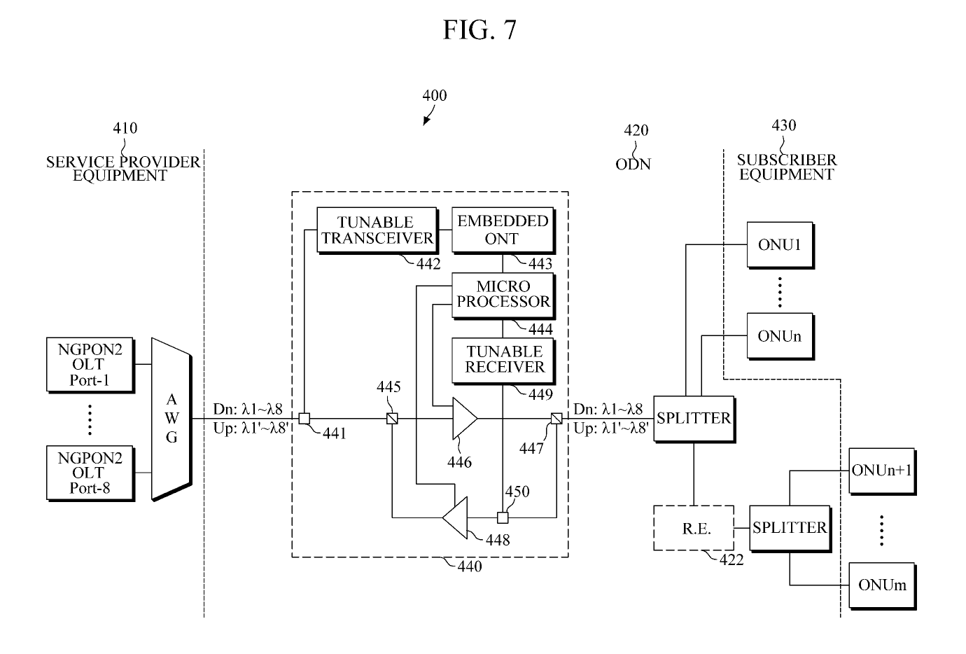

FIG. 7 is a configuration diagram illustrating a TWDM-PON system including an RE according to another exemplary embodiment of the present invention. Referring to FIG. 7, a TWDM-PON system 400 includes a service provider equipment 410, an ODN 420, and a subscriber equipment 430. The configurations of the service provider equipment 410, the ODN 420 and the subscriber equipment 430 in FIG. 7 are merely exemplary. In addition, the TWDM-PON system 400 further includes an RE 440 that is inserted into the ODN 420. For example, the RE 440 may be arranged between the service provider equipment 410 and the ODN 420, but the present disclosure is not limited thereto. In addition, the TWDM-PON system 400 shown in FIG. 7 is different from the TWDM-PON system 300 shown in FIG. 6 in that the TWDM-PON system 400 further includes an upstream splitter 450 and a tunable receiver 449, and the upstream splitter 450 and the tunable receiver 449 are described in detail in the following.

The service provider equipment 410 may include only one OLT or a plurality of OLTs. In FIG. 7, each of the OLTs constituting the service provider equipment 410 may be a device that provides a service using multiple wavelengths. Alternatively, each of the OLTs constituting the service provider equipment 410 may be a device that provides a service using a single wavelength, and, in this case, the service provider equipment 410 includes a plurality of OLTs. FIG. 7 demonstrates a case where the service provider equipment 410 includes eight NGPON2 OLTs (Port-1˜Port-8), but it is merely exemplary. The service provider equipment 410 including a plurality of NGPON2 OLTs (e.g., eight NGPON2 OLTs) may be a hybrid system that combines TDM and WDM. This configuration is appropriate to accommodate a plurality of homogeneous or heterogeneous service links using multiple-wavelength optical signals. In this case, when it is assumed that each NGPON2 OLT accommodates a single TDM PON link, an ODN accommodates n number of homogeneous or heterogeneous networks, and each service may be distinguishable according to a wavelength bandwidth of a signal that is used for a corresponding service.

The subscriber equipment 430 includes a plurality of ONUs. FIG. 7 demonstrates a case where the subscriber equipment 430 includes m number of ONUs (1 . . . n, n+1, . . . , m), but it is merely exemplary. For example, the entire subscriber equipment 430 or a part of the subscriber equipment 430 may consist of NGPON2 ONUs to receive wavelength-multiplexed downstream optical signals from a plurality of NGPON2 OLTs. To this end, the subscriber equipment 430 may include a tunable transceiver which is capable of selecting a wavelength.

The RE 440 is designed to increase a link budget of the TWDM-PON system 400 that accommodates multiple wavelengths. The basic configuration and operational principle of the RE 440 may be the same as those of the RE 200 shown in FIG. 5. Thus, the RE 440 may include a first Wavelength Division Multiplexing (WDM) filter 447 configured to amplify upstream optical signals (Up: λ1′˜λ8′), an upstream optical amplifier 448, a second WDM filter 445 configured to amplify downstream optical signals (Dn: λ1˜λ8), and a downstream optical amplifier 446. However, the TWDM-PON system 400 does not necessarily include only one RE. It means that, if necessary, the TWDM-PON system 400 may further include a single RE 422 or a plurality of REs 422 on the ODN 420.

In general, the RE 440 is installed in a remote place, so it is required for a network operator to monitor an operational state of the RE 440 for maintenance and management. In the case of an RE in the conventional Gigabit-capable Passive Optical Networks (G-PON) or 10-Gigabit-capable Passive Optical Network (XG-PON), the RE is connected to a single OLT, a network operator is able to monitor an operational state of the conventional RE through communication between the OLT and the conventional RE. However, in this exemplary embodiment, the RE 440 is connected to the service provider equipment 410 consisting of a plurality of OLTs, so that a plurality of OLTs and the RE 440 have to communicate with each other using a plurality of communication link channels.

To this end, the RE 440 may further include a downstream splitter 441, a tunable transceiver 442, and an embedded Optical Network Equipment (ONT) 443. The downstream splitter 441 is configured to split a downstream optical signal. The tunable transceiver 442 is configured to receive an optical signal of a specific wavelength among downstream optical signals split by the downstream splitter 441 and to transmit an upstream optical signal corresponding to the specific wavelength. The RE 440 may further include a microprocessor 444 configured to manage an operational state of an optical module.

In addition, as described above, the RE 440 may further include an upstream splitter 450 and a tunable receiver 449. The upstream splitter 450 is configured to split an upstream optical signal, and the tunable receiver 449 is configured to receive an upstream optical signal of a specific wavelength. Using the upstream splitter 450 and the tunable receiver 449, the RR 440 is able to further provide information on an upstream optical signal to an OLT that has established communication link to the embedded ONT 443.

The tunable transceiver 442 may communicate with a specific OLT using a specific wavelength from among a plurality of OLTs constituting the service provider equipment 410, and/or may communicate with each of the plurality of OLTs. To this end, the embedded ONT 443 may be connected to an OLT corresponding to a specific wavelength, which the tunable transceiver 342 receives, from among the plurality of OLTs. That is, the embedded ONT 443 may collect information to be transmitted to an OLT, which has established communication link to the embedded ONT 443 through the tunable transceiver 442, for maintenance and management, and then the wavelength transceiver 442 may be controlled to transmit the collected information to the communication-connected OLT. For example, when the tunable transceiver 442 selects a wavelength λ1 to thereby be connected to a NGPON2 OLT Port-1, the embedded ONT 443 may transmit operational information of the RE 440 to the NGPON2 OLT Port-1.

The tunable transceiver 442 may periodically change a reception wavelength so that all OLTs (NGPON2 OLT Port-1˜NGPON2 OLT Port-8) constituting the service provider equipment 410 may establish communication link to the embedded ONT 443. In this case, the tunable transceiver 442 may change reception wavelengths sequentially according to a preset order. Accordingly, all OLT which has established communication link to the tunable transceiver 342 may be designed to receive operational information of the RE 440. Alternatively, the tunable transceiver 442 may sequentially establish communication link to all or some of the OLTs included in the service provider equipment 310, may sequentially establish communication link to all or some of the OLTs according to an order set by a specific OLT (e.g., an MGPON2 OLP Port-1), or may sequentially establish communication link to all or some of the OLTS once receipt of a request from a specific OLT.

In this embodiment, the embedded ONT 443 may generate a monitoring signal including information on an R/S physical interface supported by an OLT that has established communication link to the embedded ONT 443. The generated monitoring signal may be transmitted through the tunable transceiver 442 to an OLT that has established communication link to the embedded ONT 443. Herein, the R/S physical interface is an ONU physical interface for an ODN. In addition, the information on the R/S physical interface supported by the communication-connected OLT may include at least one of managed entity identification (ID), an administrative state, an operational state, an optical signal level, a lower optical threshold, an upper optical threshold, a transmit optical signal level, a lower transmit power threshold, an upper transmit power threshold, and a usage mode.

In addition, the embedded ONT 443 may generate a monitoring signal including information on the upstream optical amplifier 448, and the generated monitoring signal may be transmitted through the tunable transceiver 442 to an OLT has established communication link to the embedded ONT 443. The information on the upstream optical amplifier 448 may include managed entity identification (ID), an administrate state, an operational state, an RE upstream amplifier pointer, a total optical receive signal level table, a per-burst receive signal level table, a lower receive optical threshold, a lower receive optical threshold, a transmit optical signal level, a lower transmit optical threshold, and an upper transmit optical threshold.

In addition, the embedded ONT 443 may generate a monitoring signal including information on the downstream optical amplifier 446, and the generated monitoring signal is transmitted through the tunable transceiver 442 to the OLT that has communication link to the embedded ONT 443. The information on the downstream optical amplifier 446 may include at least one of managed entity ID, an administrative state, an operation state, an input optical signal level, a lower input optical threshold, an upper input optical threshold, an output optical signal level, a lower output optical threshold, an upper output optical threshold, and an RS splitter coupling rate.

In addition, the embedded ONT 443 may generate a monitoring signal including general indicators of the optical amplifiers 446 and 448, and the generated monitoring signal may be transmitted through tunable transceiver 44 to the communication-connected OLT 2. The general indicators of the optical amplifiers 446 and 448 may include at least one of managed entity ID, a gain, a lower gain threshold, an upper gain threshold, a target gain, device temperatures, a lower device temperature threshold, an upper device temperature threshold, a device bias current, an amplifier saturation output power, an amplifier saturation gain, and an amplifier noise figure.

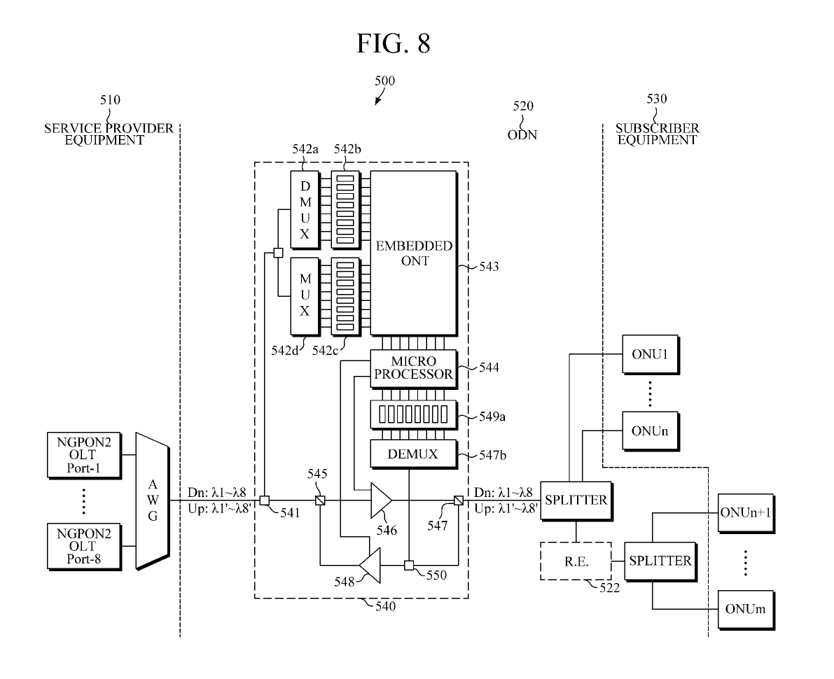

FIG. 8 is a configuration diagram illustrating a TWDM-PON system including an RE according to another exemplary embodiment of the present invention. A TWDM-PON system 500 shown in FIG. 8 is similar to the TWDM-PON system 400 shown in FIG. 7 in terms of configuration on a broad sense, but there is difference between the TWDM-PON system 500 and the TWDM-PON system 400 since the TWDM-PON system 500 includes multiple-wavelength optical transceiving device 542a, 542b, 542c and 542d and multiple-wavelength optical receiver 549a, instead of the tunable transceiver 442 and the tunable receiver 449. Hereinafter, the TWDM-PON 500 is described mainly about the differences from the TWDM-PON system 400 in FIG. 7. Accordingly, for any descriptions not provided herein, descriptions provided above with reference to FIG. 7 may be applied.

Referring to FIG. 8, the TWDM-PON system 500 includes a service provider equipment 510, an ODN 520, and a subscriber equipment 530. The configurations of the service provider equipment 510, the ODN 520, and the subscriber equipment 530 in FIG. 8 are merely exemplary. In addition, the TWDM-PON system 500 further includes an RE 540 that is inserted into the ODN 520. For example, the RE 540 may be arranged between the service provider equipment 510 and the ODN 520, but the present disclosure is not limited thereto.

The RE 540 in the TWDM-PON system 500 may further include an upstream splitter 550 and a multiple-wavelength receiving device which may include, for example, an upstream optical DeMux 549b and an upper multi-wavelength optical receiver 549a. The upstream multi-wavelength optical receiver 549a may be a photo diode array, but it is merely exemplary. Such a configuration of the multi-wavelength receiving device is similar to that of the TWDM-PON system 400 shown in FIG. 7. Specifically, a combination of the upstream optical DEMUX 549b and the upstream multi-wavelength optical receiver 549a corresponds to that of the tunable receiver 449 shown in FIG. 7. However, in some embodiments, the RE 540 may not include the upstream splitter 550 and the multi-wavelength optical receiving device 549a and 549b, and, in such cases, the RE 549 may be similar to the RE 340 shown in FIG. 6.

The RE 540 in the TWDM-PON system 500 further includes a multi-wavelength transceiving device. The multi-wavelength transceiving device may include downstream optical DEMUX 542a, a downstream multi-wavelength optical receiver 542b, a multi-wavelength light source 542c, and a MUX 542d. The downstream optical DEMUX 542a demultiplexes a wavelength of a downstream optical stream, and the downstream multi-wavelength optical receiver 542b receives a signal relating to the wavelength demultiplexed by the downstream optical DEMUX 542a. The downstream multi-wavelength optical receiver 542b may be a photo diode array, but it is not limited thereto. The multi-wavelength light source 542c transmits signals of multiple wavelengths, and the MUX 542D multiplexes transmission signals output from the multi-wavelength light source 542c. The multi-wavelength light source 542c may be configured as a light emitting diode array, but the present disclosure is not limited thereto. In terms of functionality, the multi-wavelength optical transceiver 542a, 542b, 542c and 542d corresponds to the tunable transceiver 342 in FIG. 6 or the tunable transceiver 442 in FIG. 7.

A TWDM-PON system according to an exemplary embodiment of the present invention may be embodied variously, including the above-described configurations.

For example, with respect to the REs 440 and 540 in the TWDM-PON systems 400 and 500, respectively, the multi-wavelength optical transceiving device 542a, 542b, 542c and 542d corresponds to the tunable transceiver 442, and the multi-wavelength optical receiving device 549a and 549b corresponds to the tunable receiver 449, but an RE (not shown) in another modified embodiment may be a combination of the multi-wavelength optical transceiving device 542a, 542b, 542c and 542d and the tunable receiver 449, or a combination of the tunable transceiver 442 and the multi-wavelength optical receiving device 549a and 549b.

In another example, an RE according to an exemplary embodiment of the present invention may be not only configured to split downstream optical signals and/or upstream optical signals to thereby obtain wavelength information thereof, but also configured to comprise a tunable receiver or a multi-wavelength optical receiving device to receive an optical signal split by a splitter that is further installed at a back-end of comprise a downstream optical amplifier 346, 446 or 546 (see FIGS. 6 to 8) and/or an upstream optical amplifier 348, 448 or 548.

According to the exemplary embodiments of the present invention, by applying an RE, which fits for properties of a burst-mode upstream signal and is capable of communicating with each OLT, in a TWDM-PON system, it is possible to increase a link budget of the TWDM-PON system to thereby extend transmission reach. In addition, each OLT may be able to obtain operational information of each channel in the TWDM-PON system, so that a service provider may monitor an operational state of the inserted RE to thereby easily maintain or effectively manage the system.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A Time Wavelength Division Multiplexing-Passive Optical Network (TWDM-PON) system comprising:
a service provider equipment configured to comprise a plurality of Optical Line Terminals (OLTs), wherein each of the plurality of OLT provides a service using an optical signal of different wavelength in Time Division Multiplexing (TDM) scheme;
a subscriber equipment configured to comprise a plurality of an Optical Network Units (ONUs), wherein each of the plurality of ONUs utilizes a service provided from one of the plurality of OLTs using an optical signal of an predetermined wavelength, the predetermined wavelength being selected according to wavelength control of the service provider equipment;
an Optical Division Network (ODN) configured to transmit multi-wavelength downstream optical signals from the service provider equipment to the subscriber equipment and to transmit multi-wavelength upstream optical signals transmitted from the subscriber equipment to the service provider equipment; and
a Reach Extender (RE) configured to comprise at least one of a downstream optical amplifier and an upstream optical amplifier, wherein the downstream optical amplifier is configured to amplify the multi-wavelength optical signals simultaneously, and the upstream optical amplifier is configured to amplify the multi-wavelength optical signals simultaneously.

2. The TWDM-PON system of claim 1, wherein the upstream optical amplifier is a semiconductor-based optical amplifier.

3. The TWDM-PON system of claim 2, wherein the semiconductor-based optical amplifier is either a gain-clamped semiconductor optical amplifier or a raman optical fiber amplifier.

4. The TWDM-PON system of claim 1, wherein the RE is configured to comprise
a splitter configured to split the multi-wavelength downstream optical signals received from the service provider equipment;
an embedded Optical Network Equipment (ONT) configured to generate a monitoring signal that comprises information required to control an operational state of the downstream optical amplifier; and
a tunable transceiver configured to receive an optical signal of a specific wavelength from among the multi-wavelength downstream signals split by the downstream splitter, and to transmit the generated monitoring signal of a wavelength corresponding to the specific wavelength.

5. The TWDM-PON system of claim 4, wherein the monitoring signal comprises at least one of information on an R/S physical interface supported by an OLT that has established communication link to the embedded ONT, information on the downstream optical amplifier, and general indicators of the downstream optical amplifiers.

6. The TWDM-PON system of claim 5, wherein the information on an R/S physical interface comprises at least one of managed entity identification (ID), an administrative state, an operational state, an optical signal level, a lower optical threshold, an upper optical threshold, a transmit optical level, a lower transmit power threshold, an upper transmit power threshold, and a usage mode.

7. The TWDM-PON system of claim 6, wherein the information on the downstream optical amplifier comprises at least one of managed entity ID, an administrative state, an operation state, ARC, an ARC interval, an input optical signal level, a lower input optical signal threshold, an upper input optical signal threshold, an output optical signal level, a lower output optical signal threshold, an upper output optical threshold, and an RS splitter coupling rate.

8. The TWDM-PON system of claim 5, wherein the general indicators of the downstream optical amplifiers comprise at least one of managed entity ID, a gain, a lower gain threshold, an upper gain threshold, a target gain, device temperatures, a lower device temperature threshold, an upper device temperature threshold, a device bias current, an amplifier saturation output power, an amplifier saturation gain, and an amplifier noise figure.

9. The TWDM-PON system of claim 4, wherein the RE is further configured to comprise
an upstream splitter configured to split the multi-wavelength upstream optical signals received from the subscriber equipment, and
a tunable receiver configured to receive an optical signal of a specific wavelength from among the multiple-wavelength upstream optical signals split by the upstream splitter,
wherein the monitoring signal generated by the embedded ONT further comprises information required to control an operational state of the upstream optical amplifier.

10. The TWDM-PON system of claim 9, wherein the information required to control an operational state of the upstream optical amplifier comprises at least one of managed ID, an administrative state, an operational mode, an operational state, an RE upstream amplifier pointer, a total optical receive signal level table, a per burst receive signal level table, a lower receive optical threshold, an upper receive optical threshold, a transmit optical level, a lower transmit optical threshold, and an upper transmit optical threshold.

11. The TWDM-PON system of claim 4, wherein the embedded ONT establishes communication link to the plurality of OTL sequentially to transmit the monitoring signal to each OLT that has established communication link thereto.

12. The TWDM-PON system of claim 4, wherein the embedded ONT establishes communication link to one OLT among a plurality of OLTs in response to a control signal from the specific OLT, so that the embedded ONT transmits the monitoring signal to the OLT.

13. The TWDM-PON system of claim 1, wherein the RE is configured to compromise
a splitter configured to split the multi-wavelength downstream optical signals received from the service provider equipment;
an embedded ONT configured to generate a monitoring signal that comprises information required to control an operational state of the downstream optical amplifier, and
a multi-wavelength optical receiver configured to comprise a downstream optical DeMux, a downstream multi-wavelength receiver, a multi-wavelength light source and a mux, wherein the downstream optical DeMux is configured to demultiplex the multi-wavelength downstream optical signals split by the downstream splitter, a downstream multi-wavelength receiver is configured to receive downstream optical signals that are demultiplexed by the downstream optical DeMux, a multi-wavelength light source is configured to transmit signals of various wavelengths, and a mux is configured to multiplex the signals of various wavelengths output from the multi-wavelength light source.

14. The TWDM-PON system of claim 13, wherein the monitoring signal comprises at least one of an R/S physical interface supported by an OLT that has established communication link to the embedded ONT, information on the downstream optical amplifier, and general indicators of the downstream optical amplifier.

15. The TWDM-PON system of claim 13, wherein the RE is further configured to comprise
an upstream splitter configured to split the multi-wavelength upstream optical signals received from the subscriber equipment;
an upstream DeMux configured to demultiplex the multi-wavelength upstream optical signals split by the upstream splitter; and
a tunable receiver configured to receive the upstream optical signals demultiplexed by the upstream DeMux,
wherein the monitoring signal generated by the embedded ONT further comprises information required to control an operational state of the upstream optical amplifier.

16. A Reach Extender (RE) for increasing a link budget of a Time Wavelength Division Multiplexing-Passive Optical Network (TWDM-PON) system, the RE comprising:
a downstream splitter configured to split multi-wavelength downstream optical signals received from a service provider equipment in the TWDM-PON system;
an embedded Optical Network Equipment (ONT) configured to generate a monitoring signal that comprises information required to control an operational state of the downstream optical amplifier; and
a tunable transceiver configured to receive an optical signal of a specific wavelength from among the multi-wavelength downstream optical signals split by the downstream splitter, and to transmit the generated monitoring signal of a wavelength corresponding to the specific wavelength.

17. The RE of claim 16, wherein the monitoring signal comprises at least one of an R/S physical interface supported by an OLT that has established communication link to the embedded ONT, information on the downstream optical amplifier, and general indicators of the downstream optical amplifier.

18. The RE of claim 16, further comprising:
an upstream splitter configured to split the multi-wavelength upstream optical signals received from the subscriber equipment; and
a tunable receiver configured to receive an optical signal of a specific wavelength from among the multi-wavelength upstream optical signals split by the upstream splitter,
wherein the generated monitoring signal further comprises information required to control an operational state of the upstream optical amplifier.

19. The RE of claim 16, wherein the embedded ONT establishes communication link to a plurality of Optical Line Terminals (OLTs) sequentially to transmit the monitoring signal to each OLT that has established communication link thereto.

20. The RE of claim 16, wherein the embedded ONT establishes communication link to one OLT among a plurality of OLTs in response to a control signal from the OLT so that the embedded ONT transmits the monitoring signal to the OLT.
